(19) United States
(12) Patent Application Publication
(10) Pub. No.: US 2015/0161986 A1
(43) Pub. Date: Jun. 11, 2015

(54) DEVICE-BASED PERSONAL SPEECH RECOGNITION TRAINING

(71) Applicant: INTEL CORPORATION, SANTA CLARA, CA (US)

(72) Inventors: Omesh Tickoo, Portland, OR (US); Rameshkumar G. Illikkal, Portland, OR (US); Anthony L. Chun, Los Altos, CA (US); Hector A. Cordourier Maruri, Guadalajara (MX)

(21) Appl. No.: 14/365,603

(22) PCT Filed: Dec. 9, 2013
(86) PCT No.: PCT/US2013/073901

§ 371 Date: Jun. 13, 2014

(51) Int. Cl. G10L 15/06

(52) U.S. Cl. CPC G10L 15/063

(57) ABSTRACT

In embodiments, apparatuses, methods and storage media for personalized speech recognition are described. In various embodiments, a personalized speech recognition system (“PSRS”) may receive personal speech recognition training data (“PTD”) that is associated with a user to facilitate recognition of speech from the user. The PSRS may train a speech recognition module using the received PTD. The user may provide the PTD using a mobile device under control of the user. The PTD may be generated and stored on the mobile device through actions of the user, such as by using the mobile device to record a corpus of speech examples by the user. The user may subsequently facilitate provisioning of the PTD to the PSRS using the mobile device, such as through a wired or wireless network. Other embodiments may be described and claimed.

### TECHNICAL FIELD

The present disclosure relates to the field of data processing, in particular, to apparatuses, methods and systems associated with speech recognition.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

Speech recognition, which may accept speech from a user and transcribe the speech into written text, is used in an increasing number of applications. Typically, in order to improve performance of speech recognition, a speech recognition system may be trained to recognize speech of a particular person. Such systems may provide improved quality or improved result speed compared to speech recognition systems that are trained to recognize general patterns of speech.

However, speech recognition is increasingly used in applications where it may be difficult or impossible to perform personalized training with the system prior to the speech recognition. For example, speech recognition may be used for transcription of meetings, where multiple persons may participate, few, if any of which may have had an opportunity to train the speech recognition system. In another example, speech recognition may be used in situations, such as in automated teller machines (“ATMs”), where a great many people may use the system and none may be known ahead of time. These situations increase the difficulty of providing accurate speech recognition for multiple users.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the Figures of the accompanying drawings.

FIG. 1 is a block diagram illustrating an example personalized speech recognition system configured to interact with a mobile device to facilitate recognition of speech, in accordance with various embodiments.

FIG. 2 illustrates an example process for recognizing speech, in accordance with various embodiments.

FIG. 3 illustrates an example process for generating personal speech recognition training data, in accordance with various embodiments.

FIG. 4 illustrates an example process for training the personalized speech recognition system using personal speech recognition training data, in accordance with various embodiments.

FIG. 5 illustrates an example computing environment suitable for practicing various aspects of the present disclosure, in accordance with various embodiments.

FIG. 6 illustrates an example storage medium with instructions configured to enable an apparatus to practice various aspects of the present disclosure, in accordance with various embodiments.

### DETAILED DESCRIPTION

Methods, computer-readable storage media, and apparatuses for personalized speech recognition are described. In embodiments, a personalized speech recognition system (“PSRS”) may receive personal speech recognition training data (“PTD”) that is associated with a user to facilitate recognition of speech from the user. The PSRS may be facilitated in recognizing speech by training a speech recognition module using the PTD following receipt of the PTD. In various embodiments, the PSRS may be configured to acquire the PTD through various techniques, including directly receiving the PTD from a device associated with (and/or under the control of) the user. Through training of the speech recognition module of the PSRS using the PTD, the PSRS may be provided more accurate speech recognition for the user. This improved speech recognition may be utilized in a variety of applications, such as in meeting transcription where multiple persons are speaking, or in devices, such as ATMs, where multiple unpredictable persons may utilize the device.

For example, in some embodiments, the user may provide the PTD using a mobile device under control of the user. The PTD may be generated and stored on the mobile device through actions of the user, such as by using the mobile device to record a corpus of speech examples by the user. In various embodiments, the speech examples may be processed and stored as PTD on the mobile device for later provisioning to a PSRS. The user may subsequently facilitate provisioning of the PTD to the PSRS using the mobile device, such as through a wired or wireless network. For example, the user may bring the mobile device proximate to the PSRS to initiate an automated provisioning of the PTD from the mobile device to the PSRS. In other embodiments, the PTD may be provisioned to the PSRS through other means, such as by being stored on a centralized server or other storage device, and being acquired by the PSRS based on an identifier of the user. Additional embodiments and implementation details are described herein.

In the following detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C). The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

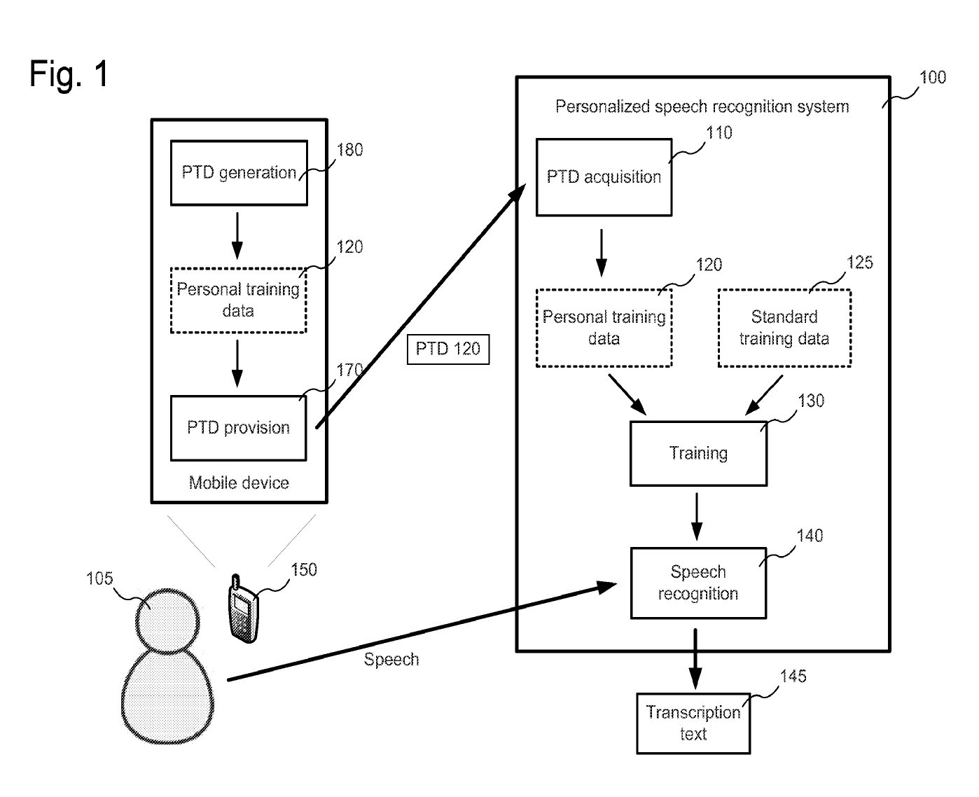

Referring now to FIG. 1, an example personalized speech recognition system 100 (“PSRS 100”) is illustrated in accordance with various embodiments. In various embodiments, the PSRS 100 may interact with a device associated with and/or under control of a user 105, such as mobile device 150, to acquire personal speech recognition training data 120 (“PTD 120”) associated with the user 105. In various embodiments, the mobile device 150 may include various devices that may be associated with and/or under control of the user 105, such as smartphones, computing tablets, and so forth.

In various embodiments, the PSRS 100 may include a speech recognition module 140, which may be configured to perform speech recognition on additional speech received from the user 105 and to produce transcription text 145 transcribing words in the additional speech from the user 105. In various embodiments, the PSRS 100 may receive audio of the additional speech from the user 105 via various techniques, such as through a microphone coupled to the PSRS 100 through wireless or wired techniques, a microphone in a separate device (such as, for example, mobile device 150), from a recording file of the additional speech from the user 105, etc.

In various embodiments, the PSRS 100 may include a training module 130 which may be configured to use speech recognition training data (such as PTD 120) to train the speech recognition module 140. In various embodiments, by training the speech recognition module 140 using PTD 120 that is specifically associated with (and, in various embodiments, produced by) the user 105, the PSRS 100 may better facilitate personalized and accurate speech recognition by the speech recognition module 140.

In various embodiments, the speech recognition module 140 may be configured to receive audio of additional speech from multiple persons and may performs speech recognition on audio from multiple persons. In various embodiments, the speech recognition module 140 may also be configured to receive multiple instances of PTD 120 associated with multiple users such that the speech recognition module 140 may use/be trained by particular instances of PTD 120 for different users. In some embodiments, the speech recognition module 140 may be configured to identify multiple users such that the proper PTD 120 may be used for speech recognition for each user. In some embodiments, the speech recognition module 140 may be configured to identify the users by receiving audio from multiple sources that are associated with users. For example, the speech recognition module 140 may be configured to receive audio from multiple microphones and to associate one or more microphones with particular users. In other embodiments, the speech recognition module 140 may be configured to perform identification of users based on the audio received from one or more microphones; this identification may be performed using one or more instances of PTD 120 according to known techniques.

In various embodiments, the PTD 120 may include various types of data that may be used to train the speech recognition module 140, as may be recognized by one of ordinary skill. For example, in various embodiments, the PTD 120 may include examples of recorded speech of the user 105 that are stored after recording with minimal (or no) processing. This recorded speech may subsequently be used by the training module 130 to train the speech recognition module 140 using known techniques. For example, the training module 130 may utilize the previous recorded speech to develop acoustic models and/or language models to be used by the speech recognition module 140. In other embodiments, the PTD 120 may include one or more models, such as acoustic models and/or language models, that may be used by the speech recognition module 140 to perform speech recognition. In various embodiments, these models may be prepared ahead of time and stored for provisioning to the PSRS 100 prior to performance of speech recognition, e.g., by speech processing applications on mobile device 150 or other devices (described in more detail below). In various embodiments, by generating acoustic and/or language models as part of the PTD 120 prior to provisioning the PTD 120, the PSRS 100 may be able to facilitate speech recognition with less training and/or on a faster basis than if more-raw data is used, such as recorded speech examples.

In various embodiments, the PTD 120 may include a substantively complete set of speech recognition training data for the training module 130 to use to train the speech recognition module 140. In such embodiments, the training module 130 may use only the PTD 120 to train the speech recognition module 140. However, in other embodiments, the training module 130 may be configured to train the speech recognition module 140 based on both the PTD 120 and standard speech recognition training data 125 (“STD 125”). The STD 125 may include speech recognition training data that is not personal to any particular user, but instead is associated with multiple users or with users of a same/common user class. For example, STD 125 may include speech recognition training data to facilitate training of the speech recognition module 140 to recognize speech of speakers of American English, male speakers of French, child speakers of Tamil, etc. In various embodiments, the PSRS 100 may be configured to utilize more than one STD 125, in particular based upon identification of the language or other demographic information about the user 105. In some such embodiments, the PTD 120 may include speech recognition data that is configured to be used along with the STD 125; such data may, in some embodiments, represent differences between speech of the user 105 and the speech recognized through training based only on the STD 125. In various embodiments, the PTD 120 may be configured such that it is encrypted or otherwise secured so that it may be associated with the user 120 and only used when authorized by the user 120.

In various embodiments, the mobile device 150 may be configured to include one or more modules to facilitate generation of the PTD 120. For example, in various embodiments, the mobile device 150 may include a PTD generation module 180. In various embodiments, the PTD generation module 180 may be configured to acquire examples of speech from the user 105 and to generate PTD 120 based on the acquired examples of speech. In various embodiments, the PTD generation module 180 may be configured to facilitate recording of speech examples, such as through a microphone on the mobile device 150. In other embodiments, the PTD generation module 180 may utilize examples of speech that are recorded elsewhere, such as on another device, and which are provided to the PTD generation module 180 on the mobile device 150. In various embodiments, the PTD generation module 180 may be configured to generate one or more models from the examples of speech to be included in the PTD, such as acoustic and/or language models. In various embodiments, the PTD generation module 180 may be configured to generate the PTD 120 to be used for by the training module 130 along with STD 125. Particular examples of generation of PTD 120 are described below.

In various embodiments, the mobile device 150 and the PSRS 100 may be configured to interoperate to facilitate provisioning of the PTD 120 from the PSRS 100. In various embodiments, the mobile device 150 may include a PTD provision module 170, which may be configured to provide the PSRS 100 with the PTD 120. In various embodiments, the PSRS 100 may likewise include a PTD acquisition module 110, which may be configured to communicate with the PTD provision module 170 to acquire the PTD 120.

In various embodiments, the PTD provision module 170 and the PTD acquisition module 110 may be configured to communicate using various techniques. For example, the PTD provision module 170 and the PTD acquisition module 110 may be configured to communicate via a wireless protocol, such as, for example, Bluetooth™ or other wireless protocols, to perform a discovery and provisioning process for the PTD 120. In other embodiments, the PTD acquisition module 110 may be configured to support one or more APIs to allow the PTD provision module 170 to provision the PTD 120 via a wired or wireless network. In other embodiments, the PSRS 100 may be configured to couple in a wired fashion with the mobile device 150, such as through a dock or other cable, to facilitate provisioning of the PTD 120. It may also be noted that, while examples given herein describe provisioning of the PTD 120 to the PSRS 100 from the mobile device, in other embodiments, the PTD 120 may be stored and provided from other places. For example, in various embodiments, a server or other storage may be configured to store the PTD 120 associated with the user 105; this PTD 120 may later be acquired by the PTD acquisition module 110 of the PSRS 100 in response to an indication that speech recognition for the user 105 is desired. In some embodiments, such storage may be configured to store multiple versions of PTD 120 associated with multiple users 105, so that the storage may act as a centralized repository for PTDs 120.

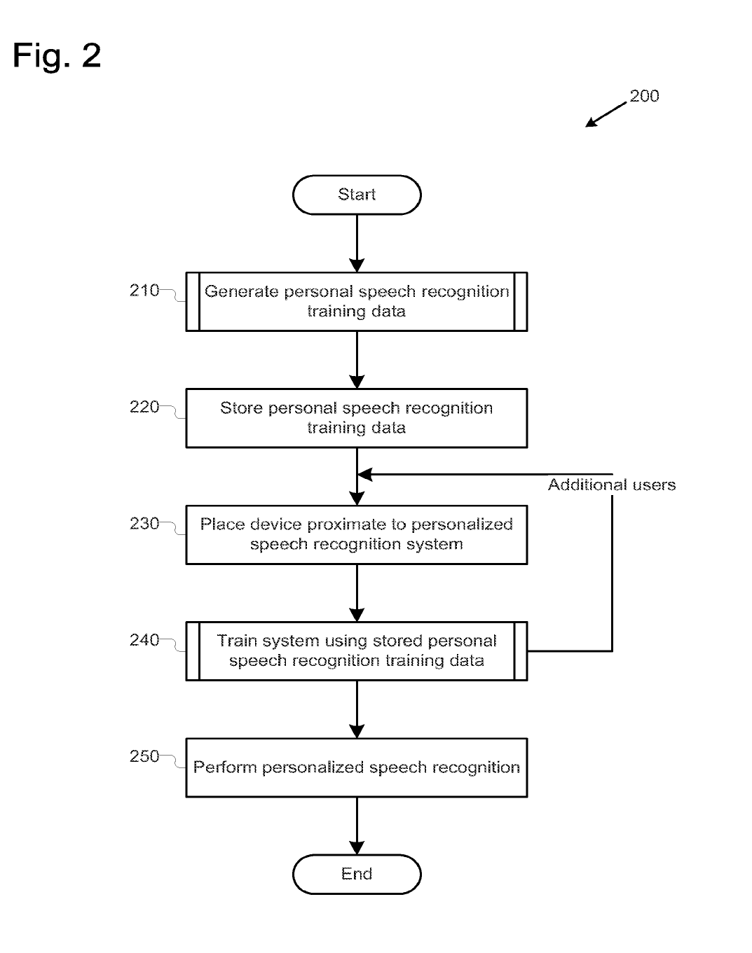

FIG. 2 illustrates an example process 200 for recognizing speech in accordance with various embodiments. While FIG. 2 illustrates particular example operations for process 200, in various embodiments, process 200 may include additional operations, omit illustrated operations, and/or combine illustrated operations. In various embodiments, process 200 may be performed by one or more entities of the PSRS 100 and/or the mobile device 150.

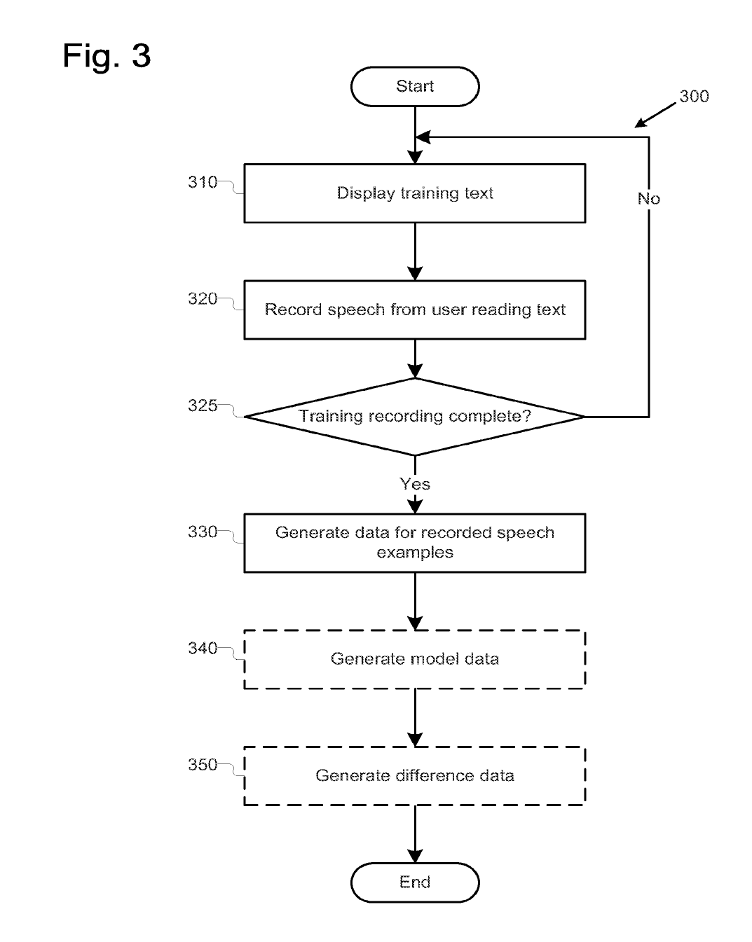

The process may begin at operation 210, where the PTD generation module 180 of the mobile device 150 may generate PTD 120. Particular examples of implementations of operation 210 are described below with reference to process 300 of FIG. 3. Next, at operation 220, the mobile device 150, and in particular the PTD generation module 180, may store the PTD 120, such as on the mobile device 150. In various embodiments, the PTD 120 may be stored on internal storage and/or removable storage of the mobile device 150. In other embodiments, after generation, the PTD 120 may be stored outside of the mobile device 150, such as on a centralized server or other storage, for later retrieval by the PSRS 100.

Next, at operation 230, the user 105 may place the mobile device 150 proximate to the PSRS 100, to begin provisioning of the PTD 120 to the PSRS 100. Such placement may be used, for example, in embodiments, where the mobile device 150 and the PSRS 100 are configured to communicate via a wireless communication protocol. However, in other embodiments, such as when the mobile device 150 and PSRS 100 are configured to communicate via wired techniques, then at operation 230 the user 105 may connect the mobile device 150 to such wired communication.

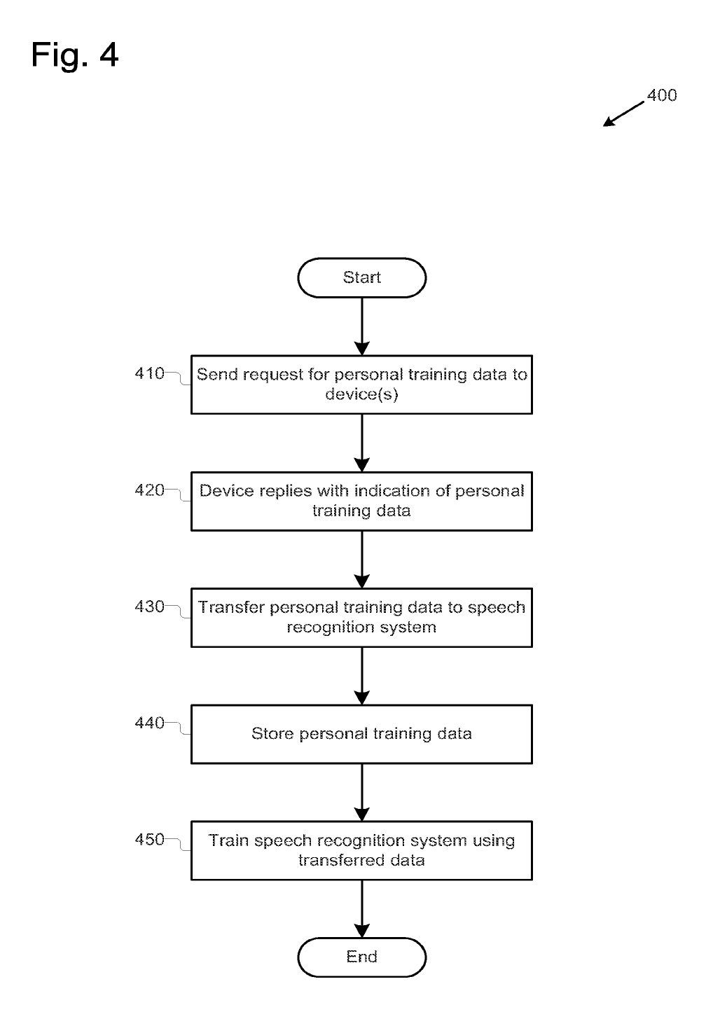

Next, at operation 240, the PSRS 100, and in particular the speech recognition module 140, may be trained using the stored PTD 120. Particular examples of implementations of operation 240 are described below with reference to process 400 of FIG. 4. In various embodiments, if other users besides user 105 are present and have generated PTD 120 for themselves, the process may repeat, such as at operation 230, for the additional users. By repeating the process for multiple users, personalized speech recognition may be facilitated in situations where multiple users are present.

Next, at 250, after being trained, the PSRS 100, and in particular the speech recognition module 140, may perform personalized speech recognition for the user 105 (as well as additional users). In various embodiments, speech recognition may be performed for multiple users contemporaneously, such as in a meeting with multiple users present. In some embodiments, speech recognition may be performed for multiple users using different microphones associated with different users, such that the speech recognition module 140 may utilize different PTD 120 and/or models to perform speech recognition for different users. After operation 250, process 200 may then end.

FIG. 3 illustrates an example process 300 for generating PTD 120, in accordance with various embodiments. Process 300 may include implementations of operation 210 of process 200 of FIG. 2. While FIG. 3 illustrates particular example operations for process 300, in various embodiments, process 300 may include additional operations, omit illustrated operations, and/or combine illustrated operations. In various embodiments, process 300 may be performed by the PTD generation module 180 of the mobile device 150.

The process may begin at operation 310, where, the PTD generation module 180 may display training text to the user 105. For example, the PTD generation module 180 may display one or more words and/or phrases to the user 105 that are predetermined to facilitate recording of a representative set of examples of speech of the user 105 that may aid in speech recognition for the user 105. At operation 320, the PTD generation module 180 may record speech from the user 105 reading the displayed text. In various embodiments, the PTD generation module 180 may record the speech using a built-in microphone of the mobile device 150; in other embodiments, other techniques for recording speech may be used. Next, at decision operation 325, the PTD generation module 180 may determine whether training is complete. In various embodiments, at decision operation 325, the PTD generation module 180 may determine whether any remaining training text exists for the PTD generation module 180 to display. In other embodiments, the PTD generation module 180 may determine, at decision operation 325, whether sufficient examples of recorded speech have been received to generate the PTD 120; if sufficient examples are present, the PTD generation module 180 may determine that recording of further examples may be unnecessary. If training is not complete, then the process may return to operation 310 for display of additional training text and further recording.

If, however, training is complete, then at operation 330, the PTD generation module 180 may generate data describing the examples of recorded speech. In some embodiments, this data may be sound data of the recorded speech examples themselves. In other embodiments, compressed data may be generated from the examples of recorded speech, using known techniques. Next, at operation 340, the PTD generation module 180 may optionally generate model data from the data describing the examples of recorded speech. Such models may be generated using known techniques for speech recognition. For example, at operation 340, acoustic and/or language models may be generated from the examples of recorded speech, as may be understood. In other embodiments, operation 340 may not be performed, and no models may be created. Next, at operation 350, the PTD generation module 180 may optionally generate difference data for the data describing the examples of recorded speech generated at operation 330 and/or the model data generated at operation 340. In various embodiments, the difference data may be generated with reference to a predetermined STD 125. In other embodiments, no difference data may be generated, and the PTD generation module 180 may generate PTD 120 describing substantially complete models or examples of recorded speech. Next, the process may end.

FIG. 4 illustrates an example process 400 for training the PSRS 100 using PTD 120, in accordance with various embodiments. Process 400 may include implementations of operation 240 of process 200 of FIG. 2. While FIG. 4 illustrates particular example operations for process 400, in various embodiments, process 400 may include additional operations, omit illustrated operations, and/or combine illustrated operations. In various embodiments, aspects of process 400 may be performed by various entities, including the PTD provision module 170 of the mobile device 150, and the PTD acquisition module 110 and training module 130 of the PSRS 100.

The process may begin at operation 410, where the PTD acquisition module 110 may send a request for PTD 120 to the mobile device 150. In various embodiments, the request may be sent via various means, such as via Bluetooth™ or other wireless communication protocols, and/or via wired means, as described herein. Next, at operation 420, the PTD provision module 170 may reply with an indication of the PTD 120 that is stored on the mobile device 150. In various embodiments, the request and reply of operations 410 and 420 may be part of a handshake protocol, as may be understood. Next, at operation 430, the PTD provision module 170 may transfer the PTD 120 to the PTD acquisition module 110. In various embodiments, the PTD provision module 170 may be configured to transfer the PTD 120 in compressed form, so as to lessen transfer time for the PTD 120. In various embodiments, the PTD provision module 170 may be configured to request authorization from the user 105 prior to providing an indication of the PTD 120 and/or prior to transferring the PTD 120 to the PTD acquisition module 110. In various embodiments, such authorization may require the entry of a password or provision of other identification of the user 105. In some embodiments this password or other identification may be provided to the mobile device 150 and/or to the PSRS 100.

After transfer, at operation 440, PTD acquisition module 110 may store the PTD 120. In various embodiments, the PTD 120 may be stored for future training and speech recognition use. Thus, in some embodiments, after an initial transfer, subsequent training and/or speech recognition for the user 105 may be performed using the stored PTD 120 without requiring communication between the mobile device 150 and the PSRS 100. It may be noted that, in alternate embodiments, rather than requiring a transfer of the PTD 120 from the mobile device 150 to the PSRS 100, the PSRS 100 may instead receive an indication of the user 105 and may acquire the PTD 120 from a server or other storage, as described herein. After the PTD acquisition module 110 acquires the PTD 120, at operation 450, the training module 130 may train the speech recognition module 140 using the PTD 120. In various embodiments, known training techniques may be used to train the speech recognition module 140. The process may then end.

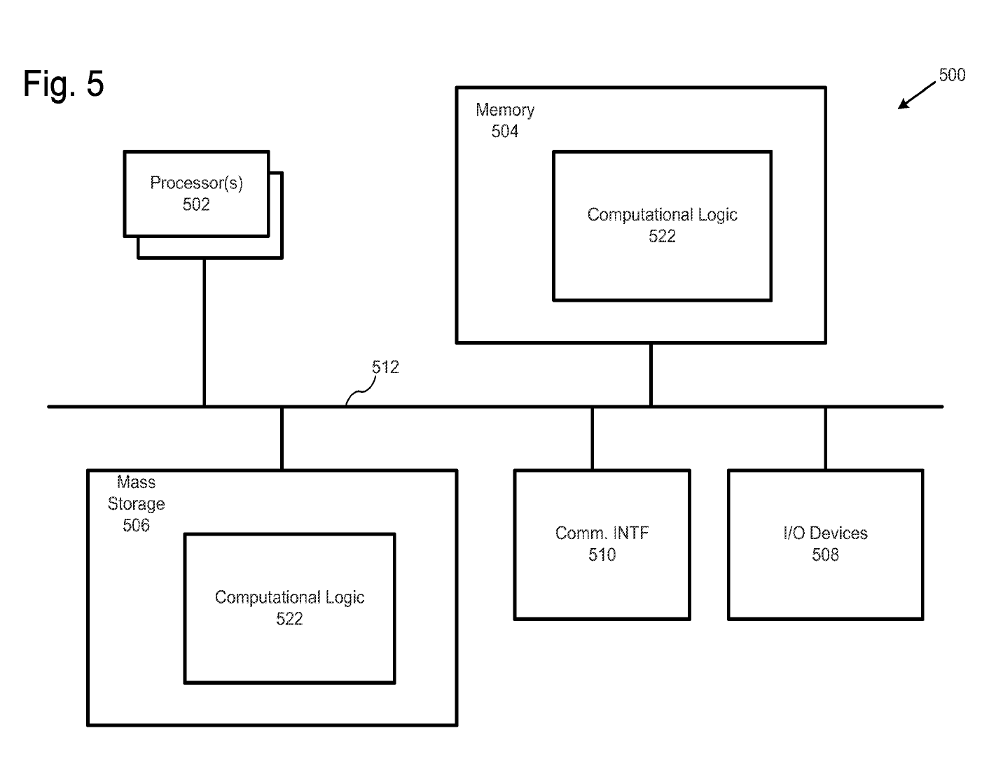

Referring now to FIG. 5, an example computer suitable for practicing various aspects of the present disclosure, including processes of FIGS. 2-4, is illustrated in accordance with various embodiments. As shown, computer 500 may include one or more processors or processor cores 502, and system memory 504. For the purpose of this application, including the claims, the terms “processor” and “processor cores” may be considered synonymous, unless the context clearly requires otherwise. Additionally, computer 500 may include mass storage devices 506 (such as diskette, hard drive, compact disc read only memory (“CD-ROM”) and so forth), input/output devices 508 (such as display, keyboard, cursor control, remote control, gaming controller, image capture device, and so forth) and communication interfaces 510 (such as network interface cards, modems, infrared receivers, radio receivers (e.g., Bluetooth), and so forth). The elements may be coupled to each other via system bus 512, which may represent one or more buses. In the case of multiple buses, they may be bridged by one or more bus bridges (not shown).

Each of these elements may perform its conventional functions known in the art. In particular, system memory 504 and mass storage devices 506 may be employed to store a working copy and a permanent copy of the programming instructions implementing the operations associated with mobile device 150 and/or PSRS 100, e.g., operations associated with personalized speech recognition, collectively referred to as computing logic 522. The various elements may be implemented by assembler instructions supported by processor(s) 502 or high-level languages, such as, for example, C, that can be compiled into such instructions.

The permanent copy of the programming instructions may be placed into permanent storage devices 506 in the factory, or in the field, through, for example, a distribution medium (not shown), such as a compact disc (“CD”), digital versatile disc, (“DVD”), or through communication interface 510 (from a distribution server (not shown)). That is, one or more distribution media having an implementation of the agent program may be employed to distribute the agent and program various computing devices.

The number, capability and/or capacity of these elements 510-512 may vary. Their constitutions are otherwise known, and accordingly will not be further described.

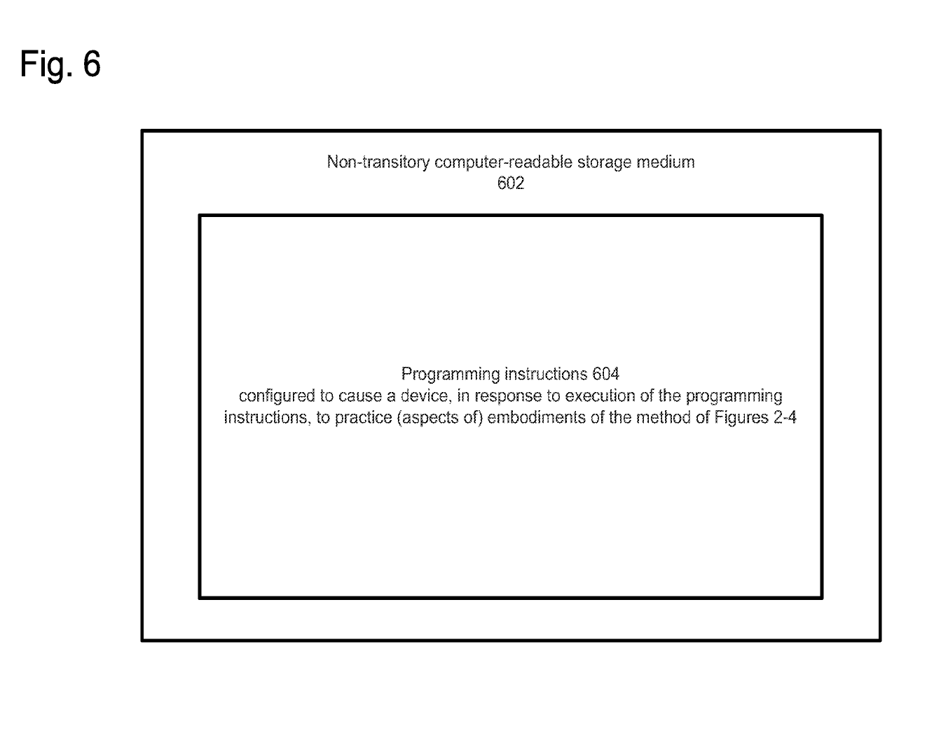

FIG. 6 illustrates an example least one non-transitory computer-readable storage medium 602 having instructions configured to practice all or selected ones of the operations associated with mobile device 150 and/or PSRS 100, e.g., operations associated with personalized speech recognition, earlier described, in accordance with various embodiments. As illustrated, the at least non-transitory one computer-readable storage medium 602 may include a number of programming instructions 604. Programming instructions 604 may be configured to enable a device, e.g., computer 500, mobile device 150, and/or PSRS 100, in response to execution of the programming instructions, to perform, e.g., various operations of processes of FIGS. 2-4, e.g., but not limited to, to the various operations performed to perform personalized speech recognition. In alternate embodiments, programming instructions 604 may be disposed on multiple at least non-transitory one computer-readable storage media 602 instead.

Referring back to FIG. 5, for one embodiment, at least one of processors 502 may be packaged together with memory having computational logic 522 configured to practice aspects of processes of FIGS. 2-4. For one embodiment, at least one of processors 502 may be packaged together with memory having computational logic 522 configured to practice aspects of processes of FIGS. 2-4 to form a System in Package (“SiP”). For one embodiment, at least one of processors 502 may be integrated on the same die with memory having computational logic 522 configured to practice aspects of processes of FIGS. 2-4. For one embodiment, at least one of processors 502 may be packaged together with memory having computational logic 522 configured to practice aspects of processes of FIGS. 2-4 to form a System on Chip (“SoC”). For at least one embodiment, the SoC may be utilized in, e.g., but not limited to, a computing tablet.

Various embodiments of the present disclosure have been described. These embodiments include, but are not limited to, those described in the following paragraphs.

Example 1 includes an apparatus for facilitating speech recognition for a user, the apparatus includes one or more computing processors. The apparatus also includes a personal speech recognition training data (“PTD”) acquisition module to operate on the one or more computing processors to acquire, from a remote device of the user, PTD describing speech previously recorded by the user. The apparatus also includes a speech recognition module to operate on the one or more computing processors to receive audio of additional speech of the user and to perform speech recognition on the audio of additional speech of the user based at least in part on the PTD acquired from the remote device.

Example 2 includes the apparatus of example 1, further including a training module configured to train the speech recognition module based at least in part on the PTD.

Example 3 includes the apparatus of example 1, wherein the PTD acquisition module is to acquire the PTD through acquisition of acoustic model data generated based at least in part on the speech previously recorded by the user.

Example 4 includes the apparatus of example 1, wherein the PTD acquisition module is to acquire the PTD through acquisition of language model data generated based at least in part the speech previously recorded by the user.

Example 5 includes the apparatus of example 1, wherein the PTD acquisition module is to acquire the PTD through acquisition of PTD describing the speech previously recorded by the user on the remote device.

Example 6 includes the apparatus of example 1, wherein the PTD acquisition module is to acquire the PTD through acquisition of PTD describing differences over speech recognition training data of other users.

Example 7 includes the apparatus of example 6, wherein the other users are of a same user class.

Example 8 includes the apparatus of any of examples 1-7, wherein the PTD acquisition module is further to request the PTD from the remote device of the user.

Example 9 includes the apparatus of example 8, wherein the PTD acquisition module is to request the PTD from the remote device of the user through performance of a handshake protocol with the remote device the user.

Example 10 includes the apparatus of example 8, wherein the PTD acquisition module is to request the PTD from the remote device of the user over a wireless connection.

Example 11 includes the apparatus of example 8, wherein the PTD acquisition module is to request the PTD from the remote device of the user in response to the remote device being brought proximate to the apparatus.

Example 12 includes the apparatus of any of examples 1-11, wherein the PTD acquisition module is to perform the acquire PTD for one or more persons other than the user and the speech recognition module is to receive audio and perform speech recognition for one or more persons other than the user.

Example 13 includes the apparatus of example 12, wherein the speech recognition module is to perform speech recognition for the one or more persons contemporaneously with performance of speech recognition for the user.

Example 14 includes an apparatus for facilitating speech recognition for a user. The apparatus includes one or more computing processors. The apparatus also includes a personal speech recognition training data (“PTD”) generation module to operate on the one or more computing processors to receive recorded speech from a user and to generate PTD associated with the user based on the recorded speech. The apparatus also includes a PTD provision module to operate on the one or more computing processors to receive a request from a speech recognition device for the PTD associated with the user and to provide the PTD associated with the user to the speech recognition device for use in recognition of speech of the user.

Example 15 includes the apparatus of example 14, wherein the PTD generation module is further to record the recorded speech from the user.

Example 16 includes the apparatus of either of examples 14 or 15, wherein the PTD provision module is to receive a request from a speech recognition device for the PTD through receipt of a wireless request.

Example 17 includes the apparatus of any of examples 14-16, wherein the PTD provision module is to receive a wireless request as part of a handshake protocol.

Example 18 includes the apparatus of any of examples 14-17, wherein the PTD provision module is to receive a wireless request when the apparatus is brought proximate to the speech recognition device.

Example 19 includes a method for facilitating speech recognition for a user. The method includes: acquiring, by a computing device, from a remote device of the user, personal speech recognition training data (“PTD”) describing speech previously recorded by the user; and receiving, by the computing device, audio of additional speech of the user; and performing speech recognition, by the computing device, on the audio of additional speech of the user based at least in part on the PTD acquired from the remote device.

Example 20 includes the method of example 19, wherein the computing device includes a speech recognition module to perform the speech recognition and the method further includes training, by the computing device, the speech recognition module based at least in part on the PTD.

Example 21 includes the method of example 19, wherein acquiring the PTD includes acquiring acoustic model data generated based at least in part on the speech previously recorded by the user.

Example 22 includes the method of example 19, wherein acquiring the PTD includes acquiring language model data generated based at least in part on the speech previously recorded by the user.

Example 23 includes the method of example 19, wherein acquiring the PTD includes acquiring PTD describing the speech previously recorded by the user on the remote device.

Example 24 includes the method of example 19, wherein acquiring the PTD includes acquiring PTD describing differences over speech recognition training data of other users.

Example 25 includes the method of example 24, wherein the other users are of a same user class.

Example 26 includes the method of any of examples 19-25, further including requesting, by the computing device, the PTD from the remote device of the user.

Example 27 includes the method of example 26, wherein requesting the PTD from the remote device of the user includes performing a handshake protocol with the remote device the user.

Example 28 includes the method of example 26, wherein requesting the PTD from the remote device of the user includes requesting the PTD from the remote device of the user over a wireless connection.

Example 29 includes the method of example 26, wherein requesting the PTD from the remote device of the user includes requesting the PTD in response to the remote device being brought proximate to the computing device.

Example 30 includes the method of any of examples 19-29, further including performing, by the computing device, the acquiring, receiving, and performing speech recognition for one or more persons other than the user.

Example 31 includes the method of example 30, wherein performing speech recognition for the one or more persons other than the user includes performing speech recognition contemporaneously with performance of speech recognition for the user.

Example 32 includes a method for facilitating speech recognition for a user. The method includes: receiving, by a computing device, recorded speech from a user; generating, by the computing device, personal speech recognition training data (“PTD”) associated with the user based on the recorded speech; receiving, by the computing device, a request from a speech recognition device for the PTD associated with the user; and providing, by the computing device, the PTD associated with the user to the speech recognition device for use in recognition of speech of the user.

Example 33 includes the method of example 32, further including recording, by the computing device, the recorded speech from the user.

Example 34 includes the method of either of examples 32 or 33, wherein receiving a request from a speech recognition device for the PTD includes receiving a wireless request.

Example 35 includes the method of any of examples 32-34, wherein receiving a request from a speech recognition device for the PTD includes performing a handshake protocol.

Example 36 includes the method of any of examples 32-35, wherein receiving a request from a speech recognition device for the PTD includes receiving the request when the computing device is brought proximate to the speech recognition device.

Example 37 includes one or more computer-readable media containing instructions written thereon to cause a computing device, in response to execution of the instructions, to facilitate speech recognition for a user. The instructions cause the computing device to: acquire, from a remote device of the user, personal speech recognition training data (“PTD”) describing speech previously recorded by the user; receive, audio of additional speech of the user; and perform speech recognition on the audio of additional speech of the user based at least in part on the PTD acquired from the remote device.

Example 38 includes the computer-readable media of example 37, wherein perform speech recognition includes perform speech recognition using a speech recognition module and the instructions are further to cause the computing device to train the speech recognition module based at least in part on the PTD.

Example 39 includes the computer-readable media of example 37, wherein acquire the PTD includes acquire acoustic model data generated based at least in part on the speech previously recorded by the user.

Example 40 includes the computer-readable media of example 37, wherein acquire the PTD includes acquire language model data generated based at least in part on the speech previously recorded by the user.

Example 41 includes the computer-readable media of example 37, wherein acquire the PTD includes acquire PTD describing the speech previously recorded by the user on the remote device.

Example 42 includes the computer-readable media of example 37, wherein acquire the PTD includes acquire PTD describing differences over speech recognition training data of other users.

Example 43 includes the computer-readable media of example 42, wherein the other users are of a same user class.

Example 44 includes the computer-readable media of any of examples 37-43, wherein the instructions are further to cause the computing device to request the PTD from the remote device of the user.

Example 45 includes the computer-readable media of example 44, wherein request the PTD from the remote device of the user includes perform a handshake protocol with the remote device the user.

Example 46 includes the computer-readable media of example 44, wherein request the PTD from the remote device of the user includes request the PTD from the remote device of the user over a wireless connection.

Example 47 includes the computer-readable media of example 44, wherein request the PTD from the remote device of the user includes request the PTD in response to the remote device being brought proximate to the computing device.

Example 48 includes the computer-readable media of any of examples 37-47, wherein the instructions are further to cause the computing device to perform the acquire, receive, and perform speech recognition for one or more persons other than the user.

Example 49 includes the computer-readable media of example 48, wherein perform speech recognition for the one or more persons other than the user includes perform speech recognition contemporaneously with performance of speech recognition for the user.

Example 50 includes one or more computer-readable media containing instructions written thereon to cause a computing device, in response to execution of the instructions, to facilitate speech recognition for a user. The instructions cause computing device to: receive recorded speech from a user; generate personal speech recognition training data (“PTD”) associated with the user based on the recorded speech; receive a request from a speech recognition device for the PTD associated with the user; and provide the PTD associated with the user to the speech recognition device for use in recognition of speech of the user.

Example 51 includes the computer-readable media of example 50, wherein the instructions are further to cause the computing device to record the recorded speech from the user.

Example 52 includes the computer-readable media of either of examples 50 or 51, wherein receive a request from a speech recognition device for the PTD includes receive a wireless request.

Example 53 includes the computer-readable media of any of examples 50-52, wherein receive a request from a speech recognition device for the PTD includes perform a handshake protocol.

Example 54 includes the computer-readable media of either of examples 50-53, wherein receive a request from a speech recognition device for the PTD includes receive the request when the computing device is brought proximate to the speech recognition device.

Example 55 includes an apparatus for facilitating speech recognition for a user. The apparatus includes: means for acquiring, from a remote device of the user, personal speech recognition training data (“PTD”) describing speech previously recorded by the user; means for receiving audio of additional speech of the user; and means for performing speech recognition on the audio of additional speech of the user based at least in part on the PTD acquired from the remote device.

Example 56 includes the apparatus of example 55, further including means for training the means for performing speech recognition based at least in part on the PTD.

Example 57 includes the apparatus of example 55, wherein means for acquiring the PTD include means for acquiring acoustic model data generated based at least in part on the speech previously recorded by the user.

Example 58 includes the apparatus of example 55, wherein means for acquiring the PTD include means for acquiring language model data generated based at least in part on the speech previously recorded by the user.

Example 59 includes the apparatus of example 55, wherein means for acquiring the PTD include means for acquiring PTD describing the speech previously recorded by the user on the remote device.

Example 60 includes the apparatus of example 55, wherein means for acquiring the PTD include means for acquiring PTD describing differences over speech recognition training data of other users.

Example 61 includes the apparatus of example 60, wherein the other users are of a same user class.

Example 62 includes the apparatus of any of examples 55-61, further including means for requesting the PTD from the remote device of the user.

Example 63 includes the apparatus of example 62, wherein means for requesting the PTD from the remote device of the user include means for performing a handshake protocol with the remote device the user.

Example 64 includes the apparatus of example 62, wherein means for requesting the PTD from the remote device of the user include means for requesting the PTD from the remote device of the user over a wireless connection.

Example 65 includes the apparatus of example 62, wherein means for requesting the PTD from the remote device of the user include means for requesting the PTD in response to the remote device being brought proximate to the apparatus.

Example 66 includes the apparatus of any of examples 55-65, wherein the means for acquiring, means for receiving, and means for performing speech recognition include means for acquiring, means for receiving, and means for performing speech recognition for one or more persons other than the user.

Example 67 includes the apparatus of example 66, wherein means for performing speech recognition for the one or more persons other than the user includes means for performing speech recognition contemporaneously with performance of speech recognition for the user.

Example 68 includes an apparatus for facilitating speech recognition for a user. The apparatus includes: means for receiving recorded speech from a user; means for generating personal speech recognition training data (“PTD”) associated with the user based on the recorded speech; means for receiving a request from a speech recognition device for the PTD associated with the user; and means for providing the PTD associated with the user to the speech recognition device for use in recognition of speech of the user.

Example 69 includes the apparatus of example 68, further including means for recording the recorded speech from the user.

Example 70 includes the apparatus of either of examples 68 or 69, wherein means for receiving a request from a speech recognition device for the PTD include means for receiving a wireless request.

Example 71 includes the apparatus of any of examples 68-70, wherein means for receiving a request from a speech recognition device for the PTD include means for performing a handshake protocol.

Example 72 includes the apparatus of any of examples 68-71, wherein means for receiving a request from a speech recognition device for the PTD includes means for receiving the request when the apparatus is brought proximate to the speech recognition device.

Computer-readable media (including least one computer-readable media), methods, apparatuses, systems and devices for performing the above-described techniques are illustrative examples of embodiments disclosed herein. Additionally, other devices in the above-described interactions may be configured to perform various disclosed techniques.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

1-25. (canceled)

26. One or more computer-readable media containing instructions written thereon to cause a computing device, in response to execution of the instructions, to:
acquire, from a remote device of the user, personal speech recognition training data (“PTD”) describing speech previously recorded by the user;
receive, audio of additional speech of the user; and
perform speech recognition on the audio of additional speech of the user based at least in part on the PTD acquired from the remote device.

27. The computer-readable media of claim 26, wherein:
perform speech recognition comprises perform speech recognition using a speech recognition module; and
the instructions are further to cause the computing device to train the speech recognition module based at least in part on the PTD.

28. The computer-readable media of claim 26, wherein acquire the PTD comprises acquire acoustic model data generated based at least in part on the speech previously recorded by the user.

29. The computer-readable media of claim 26, wherein acquire the PTD comprises acquire language model data generated based at least in part on the speech previously recorded by the user.

30. The computer-readable media of claim 26, wherein acquire the PTD comprises acquire PTD describing the speech previously recorded by the user on the remote device.

31. The computer-readable media of claim 26, wherein acquire the PTD comprises acquire PTD describing differences over speech recognition training data of other users.

32. The computer-readable media of claim 26, wherein the instructions are further to cause the computing device to request the PTD from the remote device of the user.

33. The computer-readable media of claim 32, wherein request the PTD from the remote device of the user comprises perform a handshake protocol with the remote device the user.

34. The computer-readable media of claim 32, wherein request the PTD from the remote device of the user comprises request the PTD from the remote device of the user over a wireless connection.

35. The computer-readable media of claim 32, wherein request the PTD from the remote device of the user comprises request the PTD in response to the remote device being brought proximate to the computing device.

36. The computer-readable media of claim 26, wherein the instructions are further to cause the computing device to perform the acquire, receive, and perform speech recognition for one or more persons other than the user.

37. One or more computer-readable media containing instructions written thereon to cause a computing device, in response to execution of the instructions, to:
receive recorded speech from a user;
generate personal speech recognition training data (“PTD”) associated with the user based on the recorded speech;
receive a request from a speech recognition device for the PTD associated with the user; and
provide the PTD associated with the user to the speech recognition device for use in recognition of speech of the user.

38. The computer-readable media of claim 37, wherein the instructions are further to cause the computing device to record the recorded speech from the user.

39. The computer-readable media of either of claim 37, wherein receive a request from a speech recognition device for the PTD comprises perform a handshake protocol.

40. The computer-readable media of either of claim 37, wherein receive a request from a speech recognition device for the PTD comprises receive the request when the computing device is brought proximate to the speech recognition device.

41. An apparatus, comprising:
one or more computing processors;
a personal speech recognition training data (“PTD”) acquisition module to operate on the one or more computing processors to:
acquire, from a remote device of the user, PTD describing speech previously recorded by the user; and
a speech recognition module to operate on the one or more computing processors to:
receive audio of additional speech of the user; and
perform speech recognition on the audio of additional speech of the user based at least in part on the PTD acquired from the remote device.

42. The apparatus of claim 41, further comprising a training module configured to train the speech recognition module based at least in part on the PTD.

43. The apparatus of claim 42, wherein the PTD acquisition module is further to request the PTD from the remote device of the user.

44. The apparatus of claim 43, wherein the PTD acquisition module is to request the PTD from the remote device of the user in response to the remote device being brought proximate to the apparatus.

45. The apparatus of claim 41, wherein:
the PTD acquisition module is to perform the acquire PTD for one or more persons other than the user; and
the speech recognition module is to receive audio and perform speech recognition for one or more persons other than the user.

46. A method, comprising:
acquiring, by a computing device, from a remote device of the user, personal speech recognition training data (“PTD”) describing speech previously recorded by the user;
receiving, by the computing device, audio of additional speech of the user; and
performing speech recognition, by the computing device, on the audio of additional speech of the user based at least in part on the PTD acquired from the remote device.

47. The method of claim 46, wherein:
the computing device comprises a speech recognition module to perform the speech recognition; and
the method further comprises training, by the computing device, the speech recognition module based at least in part on the PTD.

48. The method of claim 46, further comprising requesting, by the computing device, the PTD from the remote device of the user.

49. The method of claim 48, wherein requesting the PTD from the remote device of the user comprises requesting the PTD in response to the remote device being brought proximate to the computing device.

50. The method of claim 46, further comprising performing, by the computing device, the acquiring, receiving, and performing speech recognition for one or more persons other than the user.
